(19) United States
(12) Patent Application Publication
(10) Pub. No.: US 2018/0369765 A1
(43) Pub. Date: Dec. 27, 2018

(54) Gassing Reactor and Process for Producing a Gas-Liquid Mixture

(71) Applicant: IKA-Werke GmbH & Co. KG, Staufen (DE)

(72) Inventor: Christof Maier, Sulzburg (DE)

(21) Appl. No.: 16/015,369

(22) Filed: Jun. 22, 2018

(30) Foreign Application Priority Data
Jun. 22, 2017 (DE) 10 2017 113 890.0

(51) Int. Cl. B01F 7/00; B01F 3/04; B01J 10/00

(52) U.S. Cl. CPC B01F 7/00816; B01F 3/04531; B01J 10/002; B01F 2215/0036; B01F 2003/04666; B01F 2003/04879; B01F 2003/04886; B01F 2003/0468

(57) ABSTRACT

A gassing reactor is provided that comprises a dispersion stage with a rotor and a stator. The rotor and the stator respectively exhibit at least one shear surface that exhibits at least one axial component in relation to the axis of rotation of the dispersion stage. It is further provided that the gassing reactor exhibits at least one gas feed line that opens into at least one gas outlet opening into a dispersion gap of the dispersion stage formed between the rotor and the stator, delimited by the shear surfaces. In this way, the gas introduction into the liquid can be done within a range in which the maximum shear forces and highly-turbulent shear fields occurs when the gassing reactor is operating and rotor is rotating. This promotes a reliable as a fine-beaded as possible dissipation of the gas into the liquid.

### FIELD OF THE INVENTION

The invention relates to a gassing reactor that can also be designated as a gas-liquid reactor, to produce a gas-liquid mixture with at least one dispersion stage, wherein the dispersion stage comprises at least one rotor and at least one stator.

Furthermore, the invention relates to a process for producing a gas-liquid mixture.

### BACKGROUND OF THE INVENTION

Such gassing reactors and processes are already known from the prior art in various embodiments. By using such gassing reactors, a gas, for example oxygen, is introduced into a liquid and reacted with the liquid or components present therein. In particular, with gassing of a liquid with oxygen, the potential risk of ignition or even explosion associated with the oxygen must be observed. To be able to reduce or completely avoid this potential risk, the quantity of oxygen introduced must be reacted as quickly as possible so that only a sub-critical, undangerous quantity of free oxygen is present in the reactor.

### SUMMARY OF THE INVENTION

The task of the invention is therefore to provide a gassing reactor and a process of producing a gas-liquid mixture of the type defined in the preamble that simplifies the production of a gas-liquid mixture and can therefore reduce or avoid the potential risk associated with the use of many gasses.

This task is solved in a gassing reactor of the type mentioned in the preamble by the means and characteristics of independent claim 1. In particular, to solve the task in the gassing reactor mentioned in the preamble, it is proposed that a rotor and a stator respectively exhibit at least one shear surface that is arranged in at least one region axially in relation to an axis of rotation of the dispersion stage or is aligned parallel to the same or axially in relation to the same, and that the gassing reactor exhibits at least one gas feed line that opens out into a dispersion gap of the dispersion stage formed between the rotor and the stator delimited by the shear surfaces that forms at least one gas outlet opening.

In this way it is possible to introduce the gas required for the gassing reaction at a point in the gassing reactor at which, due to the rotor turning relative to the stator, highly turbulent shear fields are formed. So, the gas can be introduced through the least one gas outlet opening in a highly-turbulent swirling liquid. In this case, fine or very fine gas bubbles are produced that exhibit a large reaction surface in relation to their volume. This method promotes as fast as possible and complete reaction of the introduced gas with the liquid or components located therein. This can avoid large and potentially-dangerous free quantities of gas being transported in the liquid by the gassing reactor. In particular, when using the gassing reactor as an oxidation reactor, in which the oxygen for oxidation reactors is introduced in a liquid, the design of the gassing reactor according to the invention has the particular advantage that, in this case, the potential risk of ignition or even explosion caused by free oxygen within the liquid can be reduced or avoided. This is because the introduced oxygen reacts as quickly as possible and is no longer present as free and potentially-dangerous oxygen.

A particularly finely-beaded bubble formation can be achieved using the gassing reactor if the rotor and the stator preferably respectively exhibit at least two dispersion elements aligned axially in relation to the axis of rotation, on which the shear surfaces are formed. The at least two dispersion elements of the rotor and the stator may preferably be arranged mutually concentric and/or annular. Above all, enclosed annular dispersion elements are suitable.

The concentricity of the preferably annular dispersion elements may in this case relate to the axis of rotation of the dispersion stage of the gassing reactor. The shear planes previously mentioned that may be formed on the dispersion elements are preferably aligned parallel to the axis of rotation of the dispersion stage, therefore axially to the former.

The dispersion elements may annularly, mutually concentrically arranged webs that respectively protrude axially from the rotor and the stator.

A labyrinthine or meandering course of the dispersion gap between the rotor and the stator of the dispersion stage of the gassing reactor can be produced if at least one dispersion element of the rotor is arranged between two adjacent dispersion elements and preferably extends into or engages into a chamber or intermediate space delimited by these two adjacent dispersion elements of the stator. Such a labyrinthine or meandering dispersion gap can increase the effective dispersion surface between the rotor and stator. This can improve a finely-beaded bubble formation of the gas introduced in the dispersion gap during the dispersion stage and has the effect of an even more reliable mixing of the gas with the liquid. In addition, a dispersion stage formed in this way can contribute to maintaining the mixing of the gas with the liquid and a bubble size of the introduced gas set as small as possible.

In such an advantageous embodiment of the gassing reactor it may furthermore be provided that at least one gas outlet opening is arranged between two dispersion elements of the stator and opens into the dispersion gap between rotor and stator during the dispersion stage. In such an arrangement of at least one gas outlet opening preferably on the stator, the gas can be introduced in regions of maximum turbulence in the liquid. This promotes as quick as possible dissipation of the flow of gas into individual, very fine bubbles, that in turn increase the reaction surface of the gas bubbles and can accelerate the ongoing chemical reaction of the gas in the liquid. In this way, the free quantity of introduced gas, particularly oxygen, can be kept low or be gradually decreased during the chemical reaction. In principle, it is also conceivable to provide the at least one gas outlet opening between the two dispersion elements of the rotor and/or on the rotor.

Furthermore, the at least one gas outlet opening may be arranged opposite a radially-aligned shear surface of the rotor or the stator and open into the dispersion gap.

It may be advantageous if the gassing reactor exhibits at least two gas outlet openings, preferably distributed uniformly about the axis of rotation. So, the gas can be introduced at several places concurrently and be distributed within the liquid. Each of the gas outlet openings can be introduced through a suitable gas feed line. The gassing reactor can therefore have a simpler construction if several or all gas outlet openings are supplied from a common gas feed line. For example, this is possible if the gas outlet openings are interconnected via a respective channel, for example an annular channel or annular groove, wherein the channel can form one section of the gas feed line.

To be able largely to conclude the chemical reaction of the the gassing reactor started in the dispersion stage, but not completely finished, of the gas before an outlet of the gas liquid mixture from a reaction chamber of the gassing reactor in which the dispersion stage can be arranged, the gassing reactor may embody a reaction stage. The reaction stage may be downstream of the dispersion stage in the direction of flow of the gas-liquid mixture. Inside the reaction stage, a further blending of a gas-liquid mixture directed through the gassing reactor can be conducted. The reactor stage may be arranged, together with the dispersion stage in a common reaction chamber of the gassing reactor. By using the further blending of the gas-liquid mixture in the reaction stage, the ongoing reaction may also be accelerated and, above all, the bubble size set in the dispersion stage of the introduced gas can be maintained. So, in this downstream part of the dispersion stage of the gassing reactor, an amalgamation of fine gas beads into larger gas bubbles can be prevented.

It can be particularly advantageous if the reaction stage is formed as a further dispersion stage, in which a further dispersion as further blending of the gas-liquid mixture can be undertaken. Therefore, the reaction stage can be a further or second dispersion stage of the gassing reactor.

The reaction stage may exhibit a mixing tool rotating about an axis of rotation, for example, the one previously mentioned. This mixing tool may be a dispersion rotor. This is particularly the case if the reaction stage is formed as a further or second dispersion stage of the gassing reactor.

A length of a reaction line of the reaction stage can be of such a size that a reaction of a gas introduced in the gassing reactor with a liquid or therein introduced components at the outlet of the gas-liquid mixture from the reaction line can flow up to a defined degree or can be concluded almost completely. The aforementioned length of the reaction line can therefore be dependent on the various operating parameters of the gassing reactor, but also on the diverse parameters and properties of the liquid used and gas or gas mixture introduced.

The length of the reaction line of the reaction stage may correspond to a length of a gap formed between a rotating mixing tool of the reaction stage and a region of the gassing reactor fixed in relation to the same.

The mixing tool that can be used in the reaction stage of the gassing reactor may exhibit a plurality of particularly annular, axially-spaced mixing elements. These mixing elements may be aligned radially in relation to the axis of rotation of the mixing tool and/or be annularly closed. Therefore, a gassing reactor is created that exhibits in its dispersion stage in relation to the axis of rotation of the dispersion stage axially-aligned dispersion elements and shear surfaces and in its reaction stage in relation to the axis of rotation of the mixing tool radially-aligned mixing elements with corresponding mixing surfaces.

If the axis of rotation of the mixing tool of the reaction stage and the axis of rotation of the rotor are congruent, a particularly compact gassing reactor can be achieved. In principle, it is possible that the axis of rotation of the mixing tool of the reaction stage and the axis of rotation of the rotor of the dispersion stage are aligned mutually parallel or transverse or at right angles.

In a particularly compact embodiment of the gassing reactor it is provided that the mixing tool of the reaction stage and the rotor of the dispersion stage are arranged torque-proof on a common drive shaft. In this way, the mixing tool of the reaction stage and the rotor of the dispersion stage are interconnected by a common drive shaft. The drive shaft may be connected to a drive motor in a known way. Therefore, it is possible to use a take-off shaft of a motor as the drive shaft or connect a clutch and/or a gearbox in between the take-off shaft of the motor and the drive shaft of the gassing reactor.

The gassing reactor is preferably formed as a through-flow reactor. In this way, it is possible to enrich the gas-liquid mixture flowing through the gassing reactor during a circulation of the mixture further with gas. This promotes an easy-to-control reaction of the gas with the liquid or components located therein. Also, therefore, only comparably small quantities of gas can be introduced into the gassing reactor at any time, that is advantageous for safety reasons with gases that readily react, such as oxygen. Furthermore, the chemical reaction of the gas with the liquid or components located therein can be done completely and speedily. In a further cycle or flow-through of the gas-liquid mixture thus produced, a further gas can be introduced in sub-critical and therefore, undangerous quantities. In this way, the free quantity of gas within the liquid can be kept in a sub-critical and undangerous range and further gas continue to be supplied. This is particularly advantageous when using the gassing reactor as an oxidation reactor in which the reactor gas oxygen (O₂) or ozone (O₃) can be introduced into the gassing reactor.

The gassing reactor may, in particular, be formed as a through-flow reactor, so that one inlet opening and one outlet opening are interconnected, particularly in a reaction chamber, via corresponding lines. Therefore, it may be provided that between the outlet opening of the gassing reactor and the inlet opening in a, for example the previously mentioned, reaction chamber of the gassing reactor, a container in the form of a liquid tank is arranged. In this container, the gas-liquid mixture moves and is supplied from this for a further cycle again. In this way, a circuit is created in which the gas-liquid mixture can circulate to react the gas with the liquid.

The gassing reactor can operate particularly efficiently if the at least one dispersion stage of the gassing reactor acts as a pump stage. Therefore, it is possible, through the dispersion stage, to draw in a liquid and/or a gas and/or a gas-liquid mixture.

Furthermore, it is conceivable that a longitudinal centre axis of an intake nozzle of the gassing reactor and the axis of rotation of the dispersion stage are congruent. In this way, the liquid can be introduced through the intake nozzle of the gassing reaction in relation to the axis of rotation of and the rotor centrally into the dispersion stage. Due to the centrifugal forces occurring for dispersion when the rotor is operated, the liquid thus introduced in the dispersion stage is directed through the dispersion gas from the inside outwards past all the dispersion elements of the rotor and the stator and processed by the same, without the liquid needing to be returned inwards.

To solve the task mentioned above, the process according to the invention is proposed with the means and characteristics of the independent claim directed to the process. In particular, to solve the task, a process for producing a gas-fluid mixture, in particular by using a gassing reactor proposed according to one of claims 1 to 11, in which gas is introduced into a liquid directly in a dispersion gap delimited by the shear surfaces of a rotor and a stator of a dispersion stage. In this way, the gas is introduced to the liquid in a region with high shear forces and highly-turbulent flows. This promotes a particularly good and fine-beaded dissipation and mixing of the gas with the liquid and involves advantages illustrated in detail above.

Below, an illustrative example of the invention is described in more detail using the drawing. The invention is not restricted to this illustrative example. Further illustrative examples may be produced by combining the characteristics of individual or multiple claims with each other and/or with individual or multiple characteristics of the illustrative example.

### BRIEF DESCRIPTION OF THE DRAWINGS

FIG. 1 shows a cross-sectional view of a gassing reactor according to the invention, with a dispersion stage embodying a rotor and a stator, and a reaction stage downstream in the direction of flow of the dispersion stage provided with a rotating mixing tool.

FIG. 1 shows a part of a gassing reactor designated as a whole with gassing reactor 1 for producing a gas-liquid mixture with at least one dispersion stage 2. The dispersion stage 2 is arranged in a reaction chamber designated as 3 of the gassing reactor 1.

### DETAILED DESCRIPTION OF THE INVENTION

The dispersion stage 2 comprises a rotor 4 and a stator 5 static relative to the rotor 4, that forms an upper enclosure of the reaction chamber 3 of the gassing reactor 1, therefore also functions at least as part of a cover or enclosure of the reaction chamber 3.

The rotor 4 and the stator 5 respectively exhibit several shear surfaces 6 aligned in the direction of an axis of rotation R of the dispersion stage 2 and parallel to the former, therefore axial in relation to the axis of rotation R. The gassing reactor 1 further exhibits a gas feed line 7. The gas feed line 7 ends in at least one gas outlet opening 8 and is formed at least in one end section by a supply channel 9 that is introduced into the stator 5. The at least one gas outlet opening 8 opens directly into a dispersion gap 11 of the dispersion stage 2 formed between the rotor 4 and the stator 5, therefore within the dispersion stage 2 between the rotor 4 and the stator 5.

Both the rotor 4 and the stator 5 respectively exhibit two dispersion elements 10 respectively aligned mutually concentric, axially in relation to the axis of rotation R and enclosed and annular, between which the dispersion gap 11 is formed.

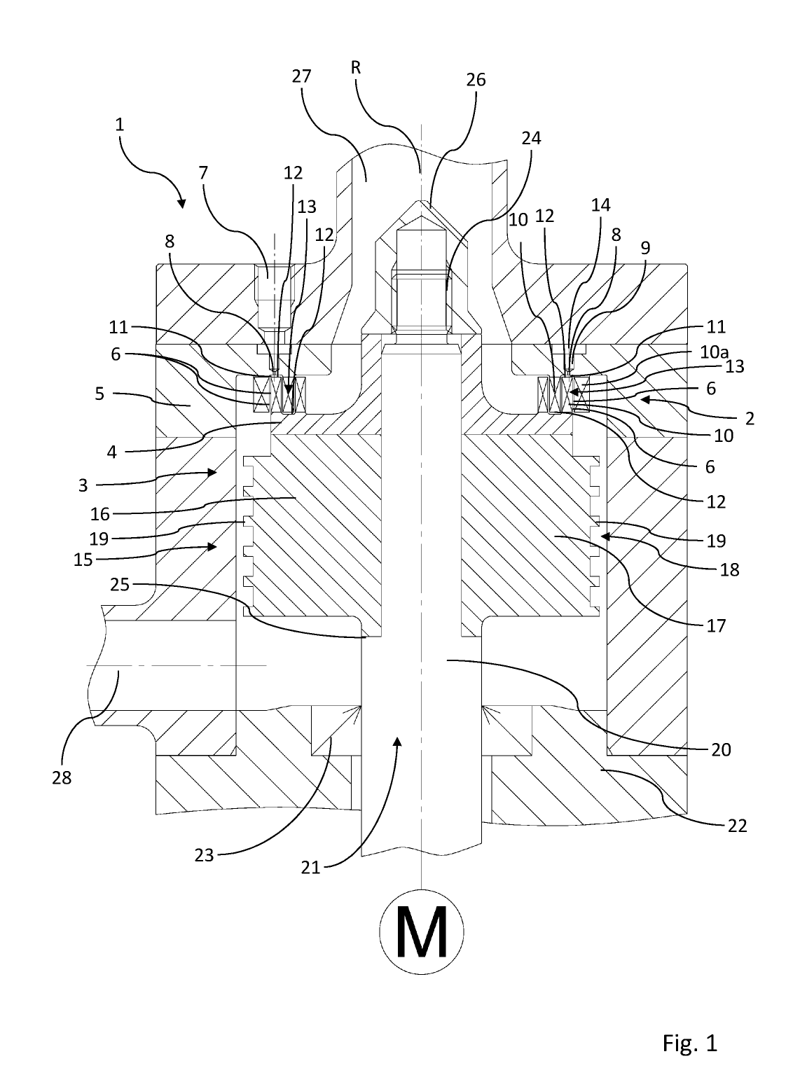

The dispersion gap 11 is delimited on the side or radially by the shear surfaces 6 already mentioned that are formed on the dispersion elements 10. FIG. 1 clearly shows that the shear surfaces 6 exhibit an axial alignment in relation to the axis of rotation R of the dispersion stage 2.

Two axially-aligned shear surfaces 6 formed on a dispersion element 10 are interconnected by a shear surface or simple abutting surface 12 aligned radially or at right angles in relation to the axis of rotation R. These abutting surfaces 12 also delimit the dispersion gap 11 extending between the rotor 4 and the stator 5, on one side and can also have a shear effect in the liquid.

By precisely considering FIG. 1, it is clear that the at least one gas outlet opening 8 opens into the dispersion gap 11 opposite an abutting shear surface 12 also delimited the dispersion gap 11.

FIG. 1 further shows that a dispersion element 10 of the rotor 4 is arranged between two adjacent dispersion elements 10 of the stator 5. The rotor 4 and the stator 5 of the dispersion stage 2 interact in such a way that also a dispersion element 10 of the stator 5 is arranged between two dispersion elements 10 of the rotor 4 and, in particular, extend into or engage with an intermediate space 13 delimited by the relevant dispersion elements 10.

In this way, the dispersion gap 11 between the rotor 4 and the stator 5 of the dispersion stage 2 includes a meandering or labyrinthine course.

The cross-sectional representation of the gassing reactor 1 according to FIG. 1 further illustrates that the gassing reactor 1 exhibits at least two gas outlet openings 8 that are arranged uniformly distributed about the axis of rotation R of the dispersion stage 2 and are in connection with the gas feed line 7 formed as a supply channel 9 in the end section via an annular channel or an annular groove 14. The groove 14 is inserted in the outside of the rotor 4 facing away from the reaction chamber 3. Using the groove 14 it is possible to dissipate gas to the at least two gas outlet openings 8 and to insert it into the dispersion stage 2 at two different places via the at least two gas outlet openings 8.

Each of the total of two gas outlet openings 8 illustrated are arranged in the stator 5 and formed as nozzles. Each of the at least two gas outlet openings 8 is provided between two dispersion elements 10 of the stator 5 and opens out opposite an abutting shear surface 12 in the dispersion gap 11 formed between the rotor 4 and the stator 5. In an embodiment of the gassing reactor 1 not shown in the figure, it may be provided that at least one gas outlet opening 8 is arranged or formed between two dispersion elements 10 of the rotor 4.

Within the reaction chamber 3 of the gassing reactor 1, the gassing reactor 1 exhibits a reaction stage 15. The reaction stage 15 is arranged downstream of the dispersion stage 2 in the direction of flow of the gas-liquid mixture and is used for a further mixing, preferably a further dispersion, of the gas-liquid mixtures directed through the gassing reactor 1. The reaction stage 15 exhibits a mixing tool 16 rotating about the already mentioned axis of rotation R, that is illustrated here as the dispersion rotor 17. Therefore, the reaction stage 15 can also be designated as the second dispersion stage of the gassing reactor 1.

A length of a reaction line 18 that is present within the reaction stage 15 and is provided by the same, is of such a size that a reaction of a gas introduced through the gas outlet openings 8 in the gassing reactor 1 and particularly into its reaction chamber 3 with a liquid or components introduced therein, is completed up to a defined degree when the gas-liquid mixture leaves the reaction line 18. A defined degree can in this case be understood that only a sub-critical and undangerous residual quantity of a free, not yet compounded or not yet reacted gas, for example oxygen, is present within the liquid.

The cross-sectional representation of a gassing reactor 1 from FIG. 1 further illustrates that the mixing tool 16 comprises a plurality of the annular, axially mutually spaced mixing elements 19 aligned radially in relation to the axis of rotation R of the mixing tool 16. Therefore, the mixing elements 19 differ at least with respect to their orientation in relation to the axis of rotation R of the dispersion elements 10 formed on the rotor 4 and stator 5 of the dispersion stage 2. The axis of rotation R of the mixing tool 16 of the reaction stage 15 is congruent with the axis of rotation R of the rotor 4 of the dispersion stage 2 and therefore obtains the same reference symbol R.

The mixing tool 16 of the reaction stage 15 and the rotor 4 of the dispersion stage 2 are arranged torque-proof on a common drive shaft 20. The drive shaft 20 is driven by a drive motor indicated with the reference symbol M in FIG. 1 and supplied with a torque. The drive shaft 20 enters a leadthrough opening designated with 21 in a lower cover 22 of the reaction chamber 3 of the gassing reactor 1 in the same. The leadthrough opening 21 is sealed by means of a shaft seal 23 against the drive shaft 20.

On its end facing away from the motor M, the drive shaft 20 exhibits a thread 24. For installation, both the mixing tool 16 and the rotor 4 are pushed over this thread 24 into a stopped position on a shaft shoulder 25 of the drive shaft 20. Using a shaft nut 26 that is screwed onto the thread 24 of the drive shaft 20, both the rotor 4 and the mixing tool 16 are pressed against the shaft shoulder 25 and fastened torque-proof to the drive shaft 20.

The gassing reactor 1 illustrated in the figure is designed and formed as a through-flow reactor. Therefore, it is provided that an inlet opening 27 and an outlet opening 28 of the gassing reactor 1, between which the reaction chamber 3 is arranged and formed, are interconnected by a corresponding line. Between the outlet opening 28 and the inlet opening 27, therefore outside the reaction chamber 3, a container, for example a tank, can be interposed, in which the gas-liquid mixture flowing out of the outlet opening 28 from the reaction chamber 3 can be buffered. The gas-liquid mixture circulates in the thus closed circuit and can finally enter the reaction chamber 3 of the gassing reactor 1 again through the inlet opening 27.

The circulation of the gas-liquid mixture described above can be maintained or produced, as the dispersion stage 2 of the gassing reactor 1 also acts as a pump stage at the same time. By using the dispersion stage 2, a liquid and also a gas can therefore be drawn in and introduced into the reaction chamber 3 of the gassing reactor 1.

The cross-sectional drawing of the gassing reactor 1 according to FIG. 1 further shows that a longitudinal centre axis of an intake nozzle 29, on which the inlet opening 27 is formed in the reaction chamber 3, and the axis of rotation R of the rotor are congruent.

With the gassing reactor 1 illustrated in FIG. 1 a gas-liquid mixture can be produced wherein the gas is introduced directly into the dispersion gap 11 delimited by the shear surfaces 6, 12 of the rotor 4 and the stator 5 of the dispersion stage 2.

The invention is concerned with improvements in the technical field of gassing reactors. To do this, among other things a gassing reactor 1 is proposed that comprises a dispersion stage 2 with a rotor 4 and a stator 5. The rotor 4 and the stator 5 respectively exhibit at least one shear surface 6 that exhibits at least one axial component in relation to the axis of rotation R of the dispersion stage 2. It is further provided that the gassing reactor 1 exhibits at least one gas feed line 7 that opens into at least one gas outlet opening 8 into a dispersion gap 11 of the dispersion stage 2 formed between the rotor 4 and the stator 5, delimited by the shear surfaces 6. In this way, the gas introduction into the liquid can be done within a region in which the maximum shear forces and highly-turbulent shear fields occurs when the gassing reactor 1 is operating and rotor 4 is rotating. This promotes a reliable and as fine-beaded as possible a dissipation of the gas into the liquid.

### LIST OF REFERENCE NUMBERS

1 Gassing reactor
2 Dispersion stage
3 Reaction chamber
4 Rotor
5 Stator
6 Side, axially aligned shear surface on 10
7 Gas feed line
8 Gas outlet opening
9 Supply channel
10 Dispersion elements
11 Dispersion gap
12 Abutting shear surface/abutting surface on 10
13 Intermediate space
14 Annular groove, annular channel
15 Reaction stage
16 Mixing tool
17 Dispersion rotor
18 Reaction line
19 Mixing elements
20 Drive shaft
21 Leadthrough opening in 22
22 Housing enclosure
23 Shaft seal
24 Thread
25 Shaft shoulder
26 Screw nut
27 Inlet opening
28 Outlet opening
M Drive motor
R Axis of rotation of 2/15

1. A gassing reactor (1) to produce a gas-liquid mixture with at least one dispersion stage (2), wherein the dispersion stage (2) comprises at least one rotor (4) and at least one stator (5), wherein the rotor (4) and the stator (5) respectively exhibit at least one shear surface (6) having in relation to an axis of rotation (R) of the dispersion stage (2) at least one axially aligned region or is arranged parallel to the axis of rotation (R) or axially in relation to the axis of rotation (R) and that the gassing reactor (1) exhibits at least one gas feed line (7), which opens into at least one gas outlet opening (8) into a dispersion gap (11) of the dispersion stage (2) formed between the rotor (4) and the stator (5) delimited by the shear surfaces (6,12).

2. A gassing reactor (1) according to claim 1, wherein the rotor (4) and the stator (5) exhibit respectively at least two, dispersion elements (10), in particular arranged mutually concentric and/or annular, aligned axially in relation to the axis of rotation (R), on which the shear surfaces (6) preferably aligned parallel to the axis of rotation (R) of the dispersion stage (2) are formed.

3. A gassing reactor (1) according to claim 2, wherein at least one dispersion element (10) of the rotor (4) is arranged between two adjacent dispersion elements (10) of the stator (5), particularly extends or engages into an intermediate space (13) delimited by the same.

4. A gassing reactor (1) according to claim 1, wherein, the at least one gas outlet opening (8) is arranged between two dispersion elements (10) of the stator (5) and/or between two dispersion elements (10) of the rotor (4) and opens out into the dispersion gap (11) between the rotor (4) and stator (5) of the dispersion stage (2), preferably wherein the at least one gas outlet opening (8) is arranged opposite an abutting, radially-aligned shear surface (12) and opens into the dispersion gap (11) and/or that the gassing reaction (1) exhibits at least two gas outlet openings (8) preferably arranged uniformly distributed about the axis of rotation (R).

5. A gassing reactor (1) according to claim 1, wherein the gassing reactor (1) exhibits a reaction stage (15) which is downstream of the dispersion stage (2) in the direction of flow of the gas-liquid mixture and in which a further mixing, preferably a further dispersion of a gas-liquid mixture directed through the gassing reactor (1) occurs, preferably wherein the dispersion stage (2) and the reaction stage (15) are arranged in a reaction chamber (3) of the gassing reactor (1).

6. A gassing reactor (1) according to claim 5, wherein the reaction stage (15) is formed as a further or second dispersion stage of the gassing reactor (1) and/or that the reaction stage (15) exhibits a mixing tool (16) rotating about one or the axis of rotation (R), in particular a dispersion rotor (17).

7. A gassing reactor (1) according to claim 5, wherein a length of a reaction line (18) of the reaction stage (15) is of such as size that a reaction of a gas introduced in the gassing reactor (1) with a liquid or therein introduced components at the outlet of the gas-liquid mixture from the reaction line (18) can flow up to a defined degree or can be concluded almost completely.

8. A gassing reactor (1) according to claim 6, wherein the mixing tool (16) exhibits a plurality of particularly annular, axially mutually spaced mixing elements (19) aligned radially in relation to the axis of rotation (R) of the mixing tool (16).

9. A gassing reactor (1) according to claim 6, wherein an axis of rotation (R) of the mixing tool (16) of the reaction stage (15) and the axis of rotation (R) of the rotor (4) of the dispersion stage (2) are aligned mutually parallel or are congruent and/or that the mixing tool (16) of the reaction stage (15) and the rotor (4) of the dispersion stage (2) are arranged torque-proof on a common drive shaft (20).

10. A gassing reactor (1) according to claim 1, wherein the gassing reactor (1) is formed as a through-flow reactor and that an inlet opening (27), particularly in the reaction chamber (3), and an outlet opening (28), particularly from the reactor chamber (3), of the gassing reactor (1) are preferably interconnected by a container.

11. A gassing reactor (1) according to claim 1, wherein the at least one dispersion stage (2) of the gassing reactor (1) acts as a pump stage, through which a liquid and/or a gas and/or a gas-liquid mixture can be drawn in, and/or that a longitudinal centre axis of an intake nozzle (29) of the gassing reactor (1) and the axis of rotation (R) of the rotor (4) are congruent.

12. A process for producing a gas-liquid mixture using a gassing reactor (1) according to claim 1, wherein gas is introduced directly into the dispersion gap (11) delimited by the at least one shear surface (6) of the rotor (4) and the stator (5) of the dispersion stage (2).
